(19) United States
(12) Patent Application Publication
(10) Pub. No.: US 2010/0007803 A1
(43) Pub. Date: Jan. 14, 2010

(54) SYSTEM AND METHOD FOR ILLUMINATING A MICRODISPLAY IMAGER WITH LOW ETANDUE LIGHT

(75) Inventor: Estill Thone Hall, JR., Fishers, IN (US)

Correspondence Address: FLETCHER YODER P.C., 7915 FM 1960 RD. WEST, SUITE 330, HOUSTON, TX, 77070, US

(73) Assignee: TTE Technology, Inc., Indianapolis, IN (US)

(21) Appl. No.: 12/441,282

(22) PCT Filed: Sep. 18, 2006
(86) PCT No.: PCT/US06/36560

§ 371 Date: Mar. 13, 2009

(51) Int. Cl. H04N 9/31; B23P 17/04

(52) U.S. Cl. 348/744; 29/592; 348/E09.025

(57) ABSTRACT

There is provided a system and method for illuminating a microdisplay with low etendue light. More specifically, in one embodiment, there is provided a video unit comprising a microdisplay imager and a light engine comprising a light source configured to produce a low etendue beam of light, and a plurality of lenses configured to shape the low etendue beam of light to correspond to one or more dimensions of the microdisplay imager.

### FIELD OF THE INVENTION

The present invention relates generally to illuminating a microdisplay imager with low etendue light. More specifically, in one embodiment, the present invention is directed to illuminating a microdisplay imager in a projection television with a laser diode.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As most people are aware, video units, such as televisions or monitors, generate images by projecting colored light at a screen. Converting light into an image, however, can be very complex. One technique for creating these images is with a microdisplay imager. A typical microdisplay imager includes a plurality of very small cells or mirrors arrayed in roughly the same dimensions as a video unit screen. Light is then projected through or reflected off the microdisplay imager to create an image on the screen. By varying the amount of power transmitted to each of the cells or mirrors, it is possible to create a wide variety of different shades. Moreover, by directing a rapidly repeating pattern of red, blue, and green light at the microdisplay imager, it is possible to create a wide range of colors.

As will be appreciated, microdisplay imaging systems tend to function best when the microdisplay imager is uniformly and efficiently illuminated. In conventional microdisplay-based video units, the microdisplay imager is usually illuminated by an arc lamp, such as an ultra high pressure (“UHP”) lamp or one or more light emitting diodes (“LEDs”). However, conventional systems may be inefficient because both lamps and LEDs propagate light in a wide arc with widely divergent angles (i.e., large etendue).

Conventional systems attempt to compensate for this wide angle by focusing the light from the lamp on a light pipe or other relay optic that focuses some portion of the light on the microdisplay imager. Unfortunately, this conventional configuration is inefficient for at least two reasons. First, the lamp or LED produces a large amount of light which is not in the angular range of the light pipe and, thus, misses the light pipe. This missed light is lost. Besides being wasted energy, this lost light may be converted into heat and adversely increase the temperature of the video unit. Second, in order to control the light from the lamp or LED efficiently (and preserve the etendue of the system), the input aperture of the light pipe is typically small, which results in correctly angled light being lost because it is in the wrong position.

A more efficient technique for uniformly illuminating a microdisplay imager would be desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for illuminating a microdisplay with low etendue light. More specifically, in one embodiment, there is provided a video unit (10) comprising a microdisplay imager (40) and a light engine (12) comprising a light source (30) configured to produce a beam of light low etendue (42), and a plurality of lenses (32, 34, 36) configured to shape the low etendue beam of light to correspond to one or more dimensions of the microdisplay imager.

### BRIEF DESCRIPTION OF THE DRAWINGS

Advantages of the invention may become apparent upon reading the following detailed description and upon reference to the drawings in which:

FIG. 1 is a block diagram of an exemplary video unit in accordance with one embodiment;

FIG. 2 is a more detailed block diagram of an exemplary light engine and microdisplay imager in accordance with one embodiment;

FIG. 3 is a diagrammatical representation of one embodiment of the light engine and a microdisplay imager; and

FIG. 4 is a block diagram of a multi-color light engine and imaging system in accordance with one embodiment.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

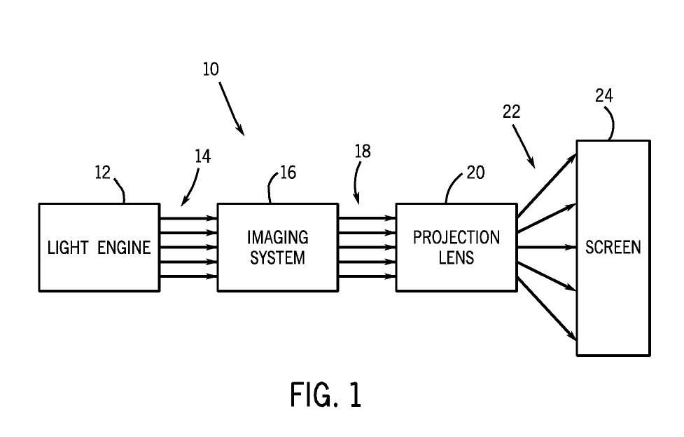

Turning initially to FIG. 1, a block diagram of an exemplary video unit configured to illuminate a microdisplay imager with low etendue light in accordance with one embodiment is illustrated and generally designated by reference numeral 10. In one embodiment, the video unit 10 may comprise a projection television. In another embodiment, the video unit 10 may comprise a video or movie projector. In still other embodiments, the video unit 10 may comprise another suitable form of video or image display technology.

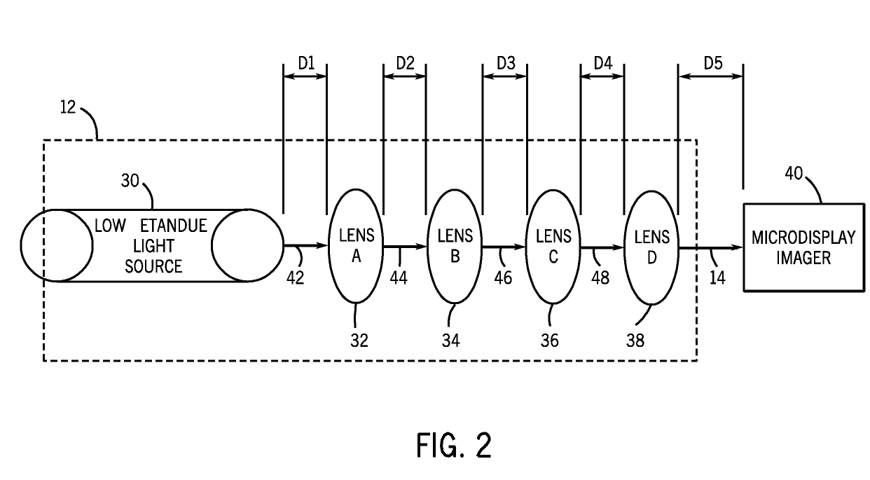

As illustrated in FIG. 1, the video unit 10 may include a light engine 12. As will be described further below with regard to FIGS. 2-4, the light engine 12 may be configured to generate light 14 suitable for illuminating a microdisplay imager within imaging system 16. The imaging system 16 may include any one of a number of suitable microdisplay imaging systems. For example, in one embodiment, the imaging system 16 may be a digital light processing (“DLP”) imaging system that includes a digital micromirror device (“DMD”) microdisplay imager. As those of ordinary skill in the art will appreciate, a DLP imaging system generates images or video by actuating one or more micromirrors on the DMD to create desired shades of light.

In another embodiment, the imaging system 16 may be a liquid crystal on silicon (“LCOS”) imaging system, which employs an LCOS microdisplay imager. In other embodiment, the imaging system 16 may be a high temperature polysilicon imaging system that includes a transmissive liquid crystal display (“LCD”) microdisplay imager. It will be appreciated, however, that the above-provided examples for the imaging system 16 are not intended to be exclusive. Accordingly, in alternate embodiments, other suitable microdisplay-based imaging systems may be employed.

The imaging system 16 may generate a light image 18, which is transmitted to one or more projection lenses 20. As those of ordinary skill in the art will appreciate, the projection lenses 20 may be configured to receive the light image 18 and expand and/or condition the light image 18 into a larger light image 22 suitable for display and/or projection onto a screen 24.

FIG. 2 is a more detailed block diagram of the exemplary light engine 12 and the exemplary imaging system 16 in accordance with one embodiment. As described above, the light engine 12 may be configured to generate the light 14 suitable for illuminating a microdisplay imager 40 in the imaging system 16. Further, as also described above, the light engine 12 may include a low etendue light source 30. As those of ordinary skill in the art will appreciate, the low etendue light source 30 may be configured to generate a low etendue light beam (i.e., a beam of tightly focused light with relatively little angular diversity). As used herein, a low etendue light beam is a light beam exhibiting generally less than a 50 degree divergence (plus or minus) from its peak brightness direction.

For example, in one embodiment, the low etendue light source 30 may be a low etendue light source, such as a laser beam source. More specifically, in one embodiment, the low etendue light source 30 may include a laser diode (i.e., a light source with a divergence of less than 10 degrees from its peak brightness direction). For example, in one embodiment, the low etendue light source 30 may include a Nichia laser diode, such as the laser diodes commonly found in Blue-Ray™ DVD players. Alternatively, other suitable laser diodes may also be employed as the low etendue light source 30. Moreover, in still other embodiments, other suitable laser producing systems or low etendue light producing systems may be employed as the low etendue light source 30.

As illustrated in FIG. 2, the light engine 12 may also include four lenses: a lens A 32, a lens B 34, a lens C 36, and a lens D 38. As will be described further below, one or more of the lenses 32, 34, 36, and 38 may be employed to uniformly and efficiently illuminate a microdisplay imager within the imaging system 16.

FIG. 2 also illustrates a distance D1 between the low etendue light source 30 and the lens A 32, a distance D2 between the lens A 32 and the lens B 34, a distance D3 between the lens B 34 and the lens C 36, a distance D4 between the lens C 36 and the lens D 38, and a distance D5 between the lens D 38 and a microdisplay imager 40. Further, FIG. 2 also illustrates a light beam 42 produced by the low etendue light source 30, which in turn becomes a light beam 44 when it passes through the lens A 32, then a light beam 46 after it passes through the lens B 34, which then becomes a light beam 48 when it passes through the lens C 36, which then becomes the light beam 14 after it passes through the lens D 38.

As mentioned above, the light engine 12 may be configured to produce the light beam 14 that uniformly illuminates the microdisplay imager 40 from the low etendue light beam 42 produced by the low etendue light source 30. More specifically, as described in greater detail below, one or more of the lenses 32-38 may be configured to control the horizontal and/or vertical growth of the low etendue light beam 42 to produce the light beam 14 which uniformly illuminates the microdisplay imager 40. As also described in further detail below, in one embodiment, one or more of the lenses 32-38 may comprise a cylindrical lens.

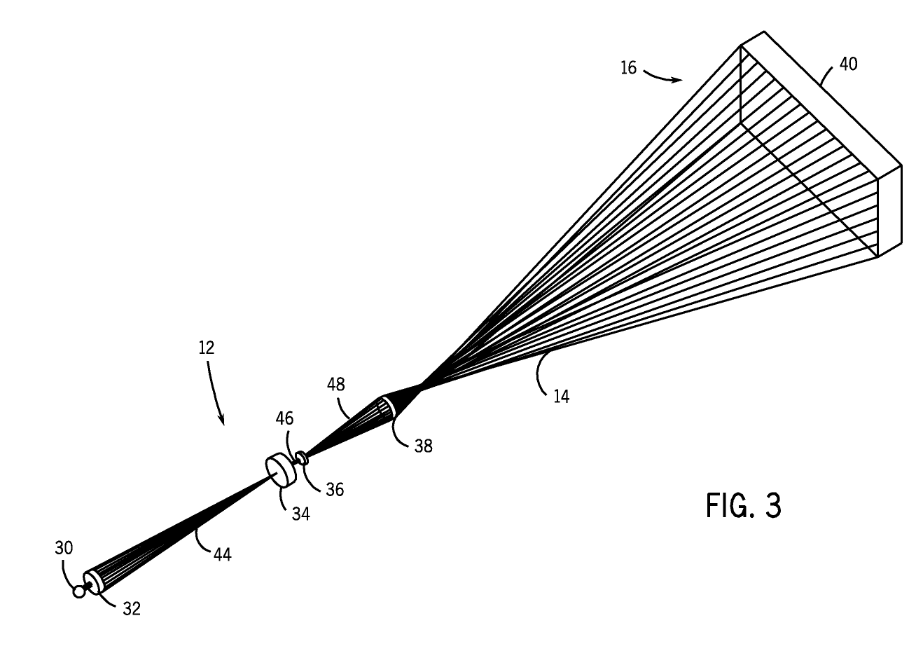

For example, FIG. 3 is a diagrammatical representation of one embodiment of the light engine 12 and the microdisplay imager 40. For simplicity, like reference numerals have been used to reference those features previously described with regard to FIG. 2. Moreover, it will be also appreciated that FIG. 3 illustrates one embodiment of the components illustrated in FIG. 2.

In the embodiment illustrated in FIG. 3, the low etendue light source 30 may include a laser diode, such as a Nichia laser diode, with an elliptical output. For example, the output ellipse of the low etendue light beam 42 generated by the low etendue light source 40 may be approximately 22 degrees by 7 degrees (i.e., an etendue of approximately 22 degree divergence from the peak brightness direction). It will be appreciated, however, that these dimensions are merely exemplary and, as such, in alternate embodiments, other suitable light beam dimensions may be employed, including non-elliptical light beams.

As illustrated, the low etendue light beam 42 may then enter the lens A 32, which may serve as a focus lens for the low etendue light source 30. For example, in one embodiment, the lens A 32 may include a GELTECH™ 350230-A astheric lens, which is available mounted from Thorlabs™ as their C230TM-A. It will be appreciated, however, that other suitable lenses may be employed as the lens A 32. Moreover, it will also be appreciated that, as the lens A 32 may serve as a focus lens for the low etendue light source 30, the lens A 32 may be associated with or sold in combination with the low etendue light source 30.

After passing through the lens A 32, the light beam 42 (now referred to as the light beam 44) may travel to the lens B 34. In the embodiment illustrated in FIG. 3, the lens B 34 may comprise a concave lens that acts as a beam expander to begin gradually expanding the light beam 44 in a generally circular and symmetrical way. For example, in one embodiment, the lens B 34 may be a Edmond Industrial Optics (“EIO”) 45383 plano concave lens. However, in alternate embodiments, other suitable lenses may be employed.

The symmetrically expanding light beam 46 may travel from the lens B 34 to the lens C 36. In the embodiment illustrated in FIG. 3, the lens C 36 may comprise a convex plano circular lens that is configured to slow down the expansion of the light beam 46 at a target level of expansion. In other words, the lens C 36 may be configured to “set” the expansion of the light beam 46 based on the dimensions of the microdisplay imager 40 such that when the light beam reaches the microdisplay imager 40 the vertical dimension of the light will correspond to the vertical dimension of the microdisplay imager 40. In one embodiment, the lens C 36 may comprise an Edmond Industrial Optics 45224 plano convex lens.

The light beam 48 may travel from the lens C 36 to the lens D 38. The lens D 38 may be configured to slow down the horizontal expansion of the light beam 48 at a size corresponding to a horizontal dimension of the microdisplay imager 40. In other words, the lens D 38 may be configured to “set” (i.e., shape) the horizontal size of the light beam 48, which is still expanding in the horizontal direction until it reaches the lens D 38. In one embodiment, the lens D 38 may comprise a cylindrical plano convex lens, such as the Edmond Industrial Optics 45981 plano convex cylindrical lens.

The light beam 14 with both its horizontal and vertical expansion corresponding to the dimensions of the microdisplay imager 40 may then be projected onto the microdisplay imager 40. As those of ordinary skill in the art will appreciate, expanding and shaping the low etendue light beam 42 produced by the low etendue light source 30, as described above, involves careful selection of both the lenses 32-38 and the distances D1, D2, D3, D4, and D5 to balance the expansion and shaping of the low etendue light beam 42. One such embodiment is described in detail below. It will be appreciated, however, that this specific embodiment, as well as other specific embodiments set forth further below, are not exclusive. Accordingly, other suitable lens types or separation distances may be employed. Moreover, it will be appreciated that the embodiments described herein were fashioned using off-the-shelf optical components (e.g., lens). As such, it will be appreciated, that other, potentially more efficient, embodiments may be fashioned using custom optical components.

As mentioned above, in one specific embodiment, the lenses and separation distances, as set forth in Table 1 below, may be employed.

TABLE 1

| | |
|---|---|
| Lens A | GELTECH_{TM}350230-A aspheric |
| Lens B | EIO 45383, plano concave lens with −27 mm focal length and |
| | 9 mm diameter |
| Lens C | EIO 45224, plano convex lens with 4 mm focal length and |
| | 4 mm diameter |
| Lens D | EIO 45981, plano convex cylindrical lens with 8 mm focal |
| | length and 5 mm diameter |
| D1 | 2.309 mm |
| D2 | 65.140 mm |
| D3 | 3.893 mm |
| D4 | 28.976 mm |
| D5 | 149.403 mm |

Simulations of the light engine 12 employing the lenses and separation distances set forth in Table 1 above resulted in 52.63% of the light generated by the low etendue light source 30 striking the microdisplay imager 40 with a minimum brightness on the microdisplay imager of 69.88% of maximum and an average brightness on the microdisplay imager of 91.53% of maximum.

Returning back to FIG. 2, in another embodiment, the lenses 32 and 34 may function substantially as described above, but the lenses 36 and 38 may be different and, thus, function differently. For example, in this alternate embodiment, the lens C 36 may comprise a convex plano circular lens that is configured to slow down the expansion of the light beam 46, and the lens D 38 may comprise a cylindrical plano concave lens that is configured to speed up the vertical expansion of the light beam 48. In other words, the lenses 36 and 38 shape the light headed for microdisplay imager 40 by slowing down its expansion in both the horizontal and vertical directions (by the lens 36), and then increasing its expansion in the vertical direction (via the lens 38) to achieve a shape corresponding to the microdisplay imager 40.

One specific example of the embodiment set forth above is provided in Table 2 below.

TABLE 2

| | |
|---|---|
| Lens A | GELTECH_{TM}350230-A aspheric |
| Lens B | EIO 45383, plano concave lens with −27 mm focal length and |
| | 9 mm diameter |
| Lens C | EIO 45078 plano convex lens with a 6 mm focal length and a |
| | 6 mm diameter |
| Lens D | EIO 46191 plano concave cylindrical lens with negative |
| | 6.25 mm focal length and 6.25 mm diameter |
| D1 | 2.145 mm |
| D2 | 32.442 mm |
| D3 | 5.920 mm |
| D4 | 8.190 mm |
| D5 | 49.058 mm |

In one simulation performed with the specific embodiment set forth in Table 2, 60.74% of light generated by the low etendue light source 30 hit the microdisplay imager 40, the minimum brightness on the microdisplay imager 40 was 76.49% of maximum, and the average brightness on the microdisplay imager 40 was 96.20% of maximum. Advantageously, the specific embodiment set forth in Table 2 employs a relatively short throw distance for the light generated by the low etendue light source (approximately 10 centimeters), but employs larger optics than the specific embodiment set forth in Table 1.

In yet another embodiment, the lens C 36 may be a plano convex cylindrical lens configured to slow down the horizontal expansion of the light beam 46, and the lens D 38 may be another plano convex cylindrical lens (of opposite orientation) configured to slow down the vertical expansion of the light beam 48. In other words, the lens C 36 may be configured to “set” the horizontal expansion, and the lens D 38 may be configured to separately “set” the vertical expansion. Alternatively, in another embodiment, the lens C 36 may be configured to slow down the vertical expansion, and the lens D 38 may be configured to slow down the horizontal expansion.

One specific example of the embodiment set forth above is presented in Table 3 below.

TABLE 3

| | |
|---|---|
| Lens A | GELTECH_{TM}350230-A aspheric |
| Lens B | EIO 45383, plano concave lens with −27 mm focal length and |
| | 9 mm diameter |
| Lens C | EIO 46015 plano convex cylindrical lens with a 25 mm focal |
| | length and a 25 mm diameter |
| Lens D | EIO 46016 plano convex cylindrical lens with a 50 mm focal |
| | length and a 25 mm diameter |
| D1 | 2.045 mm |
| D2 | 41.019 mm |
| D3 | 32.325 mm |
| D4 | 63.473 mm |
| D5 | 203.72 mm |

In simulation, the specific embodiment set forth in Table 3 resulted in 59.88% of the light generated by the low etendue light source 30 striking the microdisplay imager 40 with a minimum brightness on the imager of 74.02% of maximum and an average brightness on the microdisplay imager 40 of 97.62% of maximum.

Looking again to FIG. 2, in other embodiments, the lens D 38 may be omitted from the light engine 12. Advantageously, omitting the lens D 38 from the light engine 12 may reduce the cost of the light engine 12 while still providing sufficient illumination to the microdisplay imager 40. Embodiments omitting the lens D 38 may employ the lens B 34 to “slow down” either the horizontal expansion, the vertical expansion, or both of the light beam 44. The lens C 36 may then set the shape of the light projected on the microdisplay imager 40 by either “slowing down” or “speeding up” either the horizontal or vertical orientations of the light beam 46, as appropriate. One or more specific examples of the light engine 12 employing a three lens configuration is set forth below in Table 4. In addition, Table 4 also contains results from simulations of each of the specific embodiments.

TABLE 4

| | | D1 | D2 | D3 | D4 | % | % | % |
|---|---|---|---|---|---|---|---|---|
| Lens B | Lens C | (mm) | (mm) | (mm) | (mm) | Hit | Min | Ave |
| EIO | Oriel | 2.145 | 6 | 2 | 451 | 62% | 60% | 82% |
| 45029 | Instruments | | | | | | | |
| | (“OR”) 44005 | | | | | | | |
| EIO | OR 44005 | 2.141 | 25 | 0 | 335 | 58% | 52% | 80% |
| 45383 | | | | | | | | |
| EIO | OR 44005 | 1.900 | 21 | 0 | 446 | 48% | 71% | 96% |
| 45027 | | | | | | | | |
| EIO | OR 44005 | 2.196 | 29 | 0 | 86 | 58% | 78% | 93% |
| 45007 | | | | | | | | |

As described above, FIG. 2 illustrates the light engine 12 that is configured to illuminate the microdisplay imager 40 with low etendue light from the light source 30. For ease of description, FIG. 2 (and FIG. 3) were illustrated with a single low etendue light source. However, as those of ordinary skill in the art will appreciate, generating a color video image with a microdisplay-based imaging system 16 may employ rapidly repeating succession of red, blue, and green light.

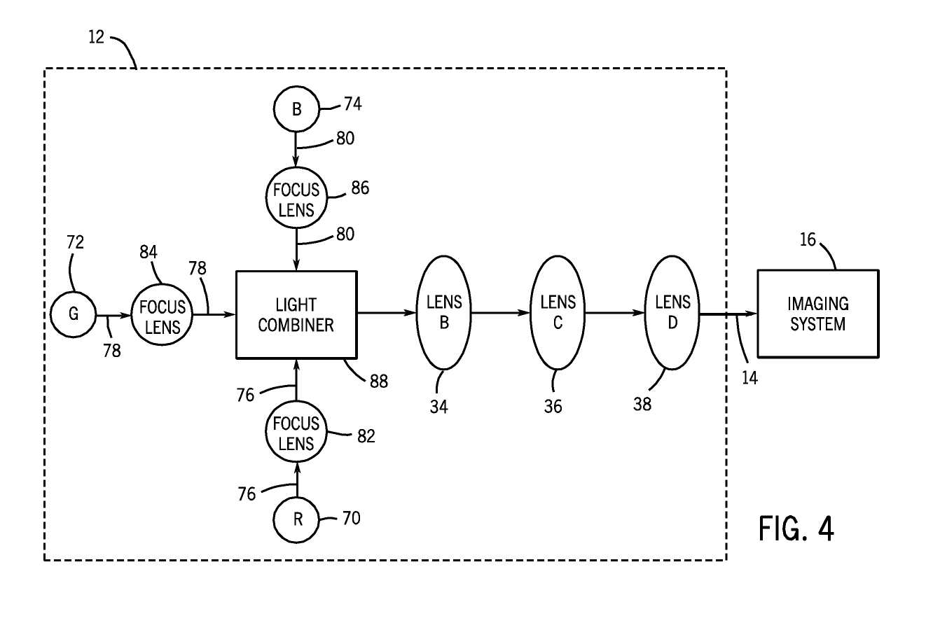

Accordingly, FIG. 4 is a block diagram of the light engine 12 configured to generate a rapidly repeating succession of red, blue, and green light. The light engine 12 illustrated in FIG. 4 also may include one or more of the lenses 34-38 that are configured to function in accordance with one of the embodiments set forth above (amongst other suitable embodiments). In addition, the multi-colored light engine 12 may also include a red low etendue light source 70, a green low etendue light source 72, and a blue low etendue light source 74. For example, in one embodiment, the multi-colored light engine 12 may include red, green, and blue laser diodes.

The light sources 70, 72, and 74 may be configured to produce red, green, and blue low etendue light beams successively. For example, the red low etendue light source 70 may be configured to generate a red low etendue light beam 76 at a first time instance, the green low etendue light source 72 may then be configured to generate a green low etendue light beam 78 at a second time instance, and then the blue low etendue light source 74 may be configured to generate a blue low etendue light beam 80 at a third time instance.

Each of the low etendue light beams 78, 80, and 82 may then travel to a respective focus lens 82, 84, or 86. More specifically, the red light beam 76 may travel to the focus lens 82, the green light beam 78 may travel to the focus lens 84, and the blue light beam 80 may travel to the focus lens 86. As will be appreciated, the focus lenses 82, 84, and 86 may be configured to focus the light beams 78, 80, and 82.

After traveling through the focus lenses 82, 84, and 86, the light beams 76, 78, and 80 maybe temporally combined by a light combiner 88, such as an X-cube. As those of ordinary skill in the art will appreciate, the light combiner 88 may be configured to receive the low etendue light beams 78, 80, and 82 and direct them along the same path towards the lens B 32 and successively the lenses 36 and 38 (if employed). In this way, by rapidly repeating the succession of red, green, and blue low etendue light (e.g., 60 times per second), the multi-colored light engine 12 is able to illuminate the microdisplay 40 within the imaging system 16 with the successive pattern of red, blue, and green light used to create color video images.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video unit comprising:
a microdisplay imager; and
a light engine comprising:
a light source configured to produce a low etendue beam of light; and
a plurality of lenses configured to shape the low etendue beam of light to correspond to one or more dimensions of the microdisplay imager.

2. The video unit of claim 1, wherein the light source comprises a laser diode.

3. The video unit of claim 2, wherein the plurality of lenses comprise:
a first lens configured as a focus lens for the laser diode; and
a second lens configured to expand the low etendue beam of light.

4. The video unit of claim 3, wherein the second lens comprises a plano concave lens.

5. The video unit of claim 3, wherein the plurality of lenses comprise a third lens configured to slow down a rate of expansion of the low etendue beam of light.

6. The video unit of claim 5, wherein the plurality of lenses comprise a fourth lens configured to further slow down a horizontal rate of expansion of the low etendue beam of light without substantially affecting the vertical rate of expansion of the low etendue beam of light.

7. The video unit of claim 6, wherein the third lens comprises a plano circular lens and the fourth lens comprises a cylindrical plano convex lens.

8. The video unit of claim 5, wherein the plurality of lenses comprise a fourth lens configured to speed up a vertical rate of expansion of the low etendue beam of light without substantially affecting the horizontal rate of expansion of the low etendue beam of light.

9. The video unit of claim 8, wherein the third lens comprises a plano circular lens and the fourth lens comprises a cylindrical plano concave lens.

10. The video unit of claim 5, wherein the plurality of lenses comprise a fourth lens configured to slow down a vertical rate of expansion of the low etendue beam of light without substantially affecting the vertical rate of expansion of the low etendue beam of light, wherein the third lens is configured to slow down a horizontal rate of expansion of the low etendue beam of light without substantially affecting the vertical rate of expansion.

11. The video unit of claim 10, wherein the third lens comprises a first plano convex cylindrical lens and the fourth lens comprises a second plano convex cylindrical lens.

12. The video unit of claim 1, wherein the microdisplay imager comprises a digital micromirror device.

13. The video unit of claim 1, wherein the microdisplay imager comprises a liquid crystal on silicon imager.

14. The video unit of claim 1, wherein the light source is configured to produce an elliptically shaped laser beam.

15. A method of manufacturing a video unit comprising:
providing a microdisplay imager;
providing a light source configured to produce a low etendue beam of light, wherein the light source is mounted such that the beam of light strikes the microdisplay imager; and
arraying a plurality of lenses between the light source and the microdisplay imager, wherein the plurality of lenses are configured to shape the low etendue beam of light to correspond to one or more dimensions of the microdisplay imager.

16. The method of claim 15, wherein array the plurality of lenses comprises arraying a first lens configured as a focus lens for the laser diode; and a second lens configured to expand the low etendue beam of light.

17. The method of claim 16, wherein the arraying the second lens comprises arraying the second lens in a position such that it expands one dimension of the low etendue beam of light to a size that corresponds to the microdisplay imager.

18. A video unit comprising:
a red laser diode configured to project a laser beam into a light combiner;
a green laser diode configured to project a laser beam into the light combiner;
a blue laser diode configured to project a laser beam into the light combiner;
a plurality of lenses optically coupled to the light combiner, wherein the plurality of lenses are configured to shape the red, green, and blue laser beams to correspond to one or more dimensions of a microdisplay imager.

19. The video unit of claim 18 wherein the red laser diode, the green laser diode, and the blue laser diode are configured to project their laser beams sequentially.

20. The video unit of claim 18, comprising the microdisplay imager, wherein the microdisplay imager comprises a transmissive liquid crystal display.
